(19) United States
(12) Patent Application Publication
(10) Pub. No.: US 2008/0219115 A1
(43) Pub. Date: Sep. 11, 2008

(54) Optical Drive Having a Laser Driver Device with an Adjustable Power Level

(75) Inventor: James Joseph Anthony Mccormack, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/091,489

(22) PCT Filed: Oct. 24, 2006
(86) PCT No.: PCT/IB2006/053899

§ 371 Date: Apr. 25, 2008

(30) Foreign Application Priority Data
Oct. 31, 2005 (EP) 05110171.5

(51) Int. Cl. G11B 5/09

(52) U.S. Cl. 369/47.28

(57) ABSTRACT

The present invention relates to an optical drive capable of writing data to an optical carrier or disk, the optical drive having a laser driver device with an adjustable power level (VSL). The optical drive has a radiation source (4) capable of emitting a radiation beam (5) for writing data with a certain writing speed to an optical carrier and a laser driver device (LDD) comprising electronic circuitry means for providing a control current to the radiation source in response to a data signal (NRZ). The electronic circuitry means is supplied by an adjustable power supply (REG_SUP, 32) having a power level (VSL) that is adapted for being adjusted in response to the data writing speed to the optical carrier. The optical drive therefore has a reduced power dissipation compared with the hitherto known solutions. This results in an increased lifetime of the radiation source, e.g. the laser, and a reduced power usage.

The present invention relates to an optical drive capable of writing data to an associated optical carrier, the optical drive having a laser driver device with an adjustable power level. The invention also relates to a corresponding laser driver device (LDD) and a method for operating an optical drive.

In recent years, optical recording on optical disks or carriers has been applied in more and more applications. This has necessitated a corresponding need for higher recording density and increase of recording speed, i.e. the speed by which data is written on the optical disk. In order to control the writing laser, a laser control signal needs to be transmitted to a laser driver in order to implement a write strategy appropriate for the data to be recorded.

In many optical drives, the write strategy is integrated with the laser driver close to the laser on the optical pick-up unit (OPU) so as to obtain a high writing quality. However, this makes power dissipation on the OPU a major problem because it leads to laser heating above the maximum allowable temperatures. This in turn shortens the laser lifetime but also causes spin-down and/or lower writing quality. Any measure that reduces dissipation especially on the OPU will aid to solve these problems. Moreover, due to the increasing demand of portable computer units like laptops, personal digital assistants (PDA) etc., battery usage is becoming a more and more important issue.

Japanese patent publication JP 2000-3396884 discloses a method for reducing the power dissipation on an OPU of an optical drive by setting a recording circuit and a control circuit of the optical drive in a non-operative state to reduce the heat generation/power consumption for operating conditions other than recording or erasing i.e. reading. The method will therefore not reduce heat generation or power dissipation during recording or erasing even though recording or erasing requires a higher laser power level than reading. Thus, this method only partly solves the problem of power dissipation on the OPU of an optical drive.

Hence, an improved optical drive would be advantageous, and in particular a more efficient and/or reliable optical drive would be advantageous.

Accordingly, the invention preferably seeks to mitigate, alleviate or eliminate one or more of the above-mentioned disadvantages singly or in any combination. In particular, it may be seen as an object of the present invention to provide an optical drive which solves, at least partly, the above-mentioned power dissipation problems of the prior art.

This object and several other objects are obtained in a first aspect of the invention by providing an optical drive capable of writing data to an associated optical carrier, the optical drive comprising:

a radiation source capable of emitting a radiation beam for writing data with a pre-determined writing speed to the associated optical carrier,

a laser driver device (LDD) comprising electronic circuitry means for providing a control current to the radiation source in response to a clock signal and a data signal,

an adjustable power supply supplying the electronic circuitry means, wherein a power level of the power supply to at least part of the electronic circuitry means is adapted for being adjusted in response to the data writing speed to the associated optical carrier.

The invention is particularly, but not exclusively, advantageous for obtaining a laser driver device of an optical drive that has a reduced power dissipation compared with the hitherto known solutions. This results in an increased lifetime of the radiation source, e.g. the laser, and a reduced power usage. These advantages of the present invention are obtained by supplying at least part of the electronic circuitry in the laser driver device with an adjusted power level depending on the current writing speed. It should be noted that this is obtained without reducing the performance and/or quality of the writing process as will be explained in more detail below.

Beneficially, the electronic circuitry means may comprise a clock generator for generating an internal clocking signal, e.g. a phase lock loop (PLL) circuitry from the clock signal, preferably so as to generate a higher resolution clocking signal needed for the writing process. Further, the electronic circuitry means may comprise a write strategy generator capable of implementing a write strategy. Additionally, the electronic circuitry means may comprise current drive means for generating the control current to the radiation source.

Moreover, the electronic circuitry means may comprise a laser driver device controller for controlling the control current to the radiation source. Parts of the electronic circuitry means may comprise logic circuitry means, such as CMOS circuitry or the like. Typically, the internal clocking signal may have a clock frequency, and said clock frequency may have a maximum value that is dependent on the power level of the power supply to the clock generator. The invention may therefore advantageously adjust the power level in accordance with the clock frequency that is needed for operating the optical drive.

Beneficially, the power level of the power supply to at least part of the electronic circuitry means may be minimized in dependence on the data writing speed to the associated optical carrier so as to obtain a low power dissipation of the optical drive, in particular on an optical pick-up unit (OPU) of the drive. Even more beneficially, the power level of the power supply to at least part of the electronic circuitry means may be adjusted in an iterative process so as to obtain a further reduction in the power dissipation.

Beneficially, the optical drive of the present invention may be operated with a writing speed profile chosen from the group of: constant angular velocity (CAV), pseudo constant angular velocity (PCAV), and zoned constant linear velocity (ZCLV). These writing speed profiles are common in that these writing speed profiles have non-constant linear velocity.

In a second aspect, the invention relates to a laser driver device (LDD) for controlling an associated radiation source for writing data with a pre-determined writing speed to an associated optical carrier in an optical drive, the laser driver device comprising:

electronic circuitry means for providing a control current to the radiation source in response to an incoming clock signal and an incoming data signal, the electronic circuitry means being adapted for being supplied by an associated adjustable power supply,

wherein at least part of the electronic circuitry means is adapted for operating with a power level being adjusted in response to the data writing speed to the associated optical carrier.

In a third aspect, the invention relates to a method for operating an optical drive capable of writing data to an optical carrier, the method comprising the steps of:

emitting a radiation beam with a radiation source for writing data with a pre-determined writing speed to the optical carrier,

providing a control current from a laser driver device (LDD) comprising electronic circuitry means for providing said control current to the radiation source in response to a clock signal and a data signal,

supplying the electronic circuitry means with an adjustable power supply, and

adjusting a power level of the power supply to at least part of the electronic circuitry means in response to the data writing speed to the optical carrier.

In a fourth aspect, the invention relates to a computer program product being adapted to enable a computer system comprising at least one computer having data storage means associated therewith to control an optical recording drive according to the third aspect of the invention.

This aspect of the invention is particularly, but not exclusively, advantageous in that the present invention may be implemented by a computer program product enabling a computer system to perform the operations of the third aspect of the invention. Thus, it is contemplated that some known optical recording apparatus or drive may be changed to operate according to the present invention by installing a computer program product on a computer system controlling the said optical recording apparatus. Such a computer program product may be provided on any kind of computer readable medium, e.g. a magnetically or an optically based medium, or through a computer based network, e.g. the Internet.

The first, second, third and fourth aspect of the present invention may each be combined with any of the other aspects. These and other aspects of the invention will be apparent from and elucidated with reference to the embodiments described hereinafter.

The present invention will now be explained, by way of example only, with reference to the accompanying Figures, where

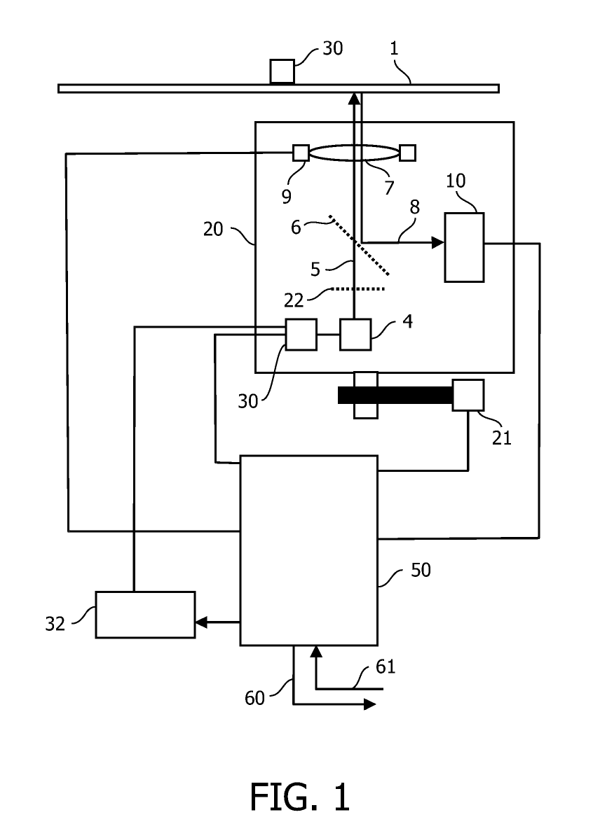

FIG. 1 is a schematic diagram of an embodiment of an optical recording drive according to the present invention,

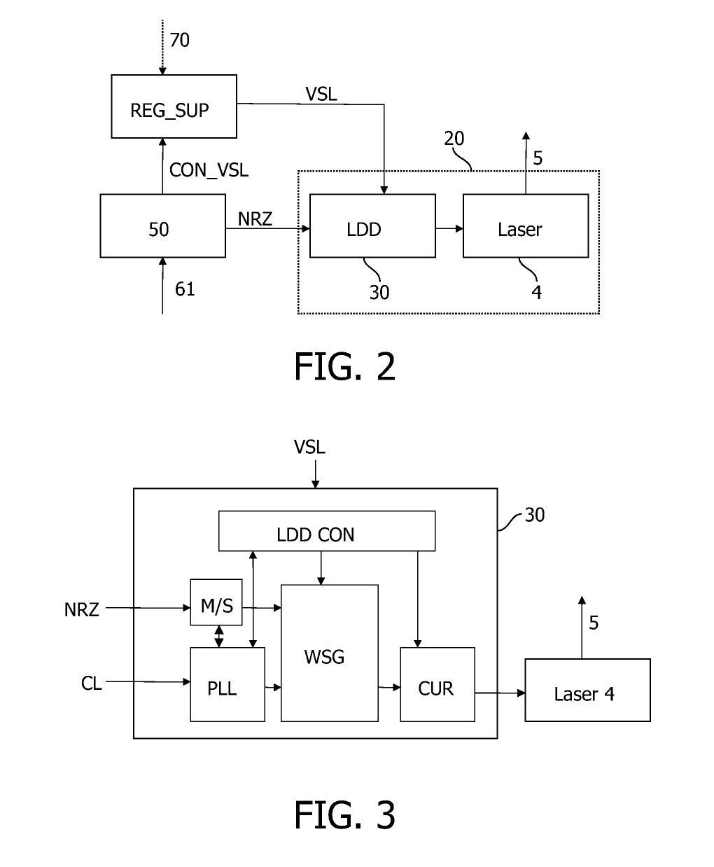

FIG. 2 illustrates the present invention in a simplified block diagram,

FIG. 3 is a block diagram of a laser driver device (LDD) according to the present invention,

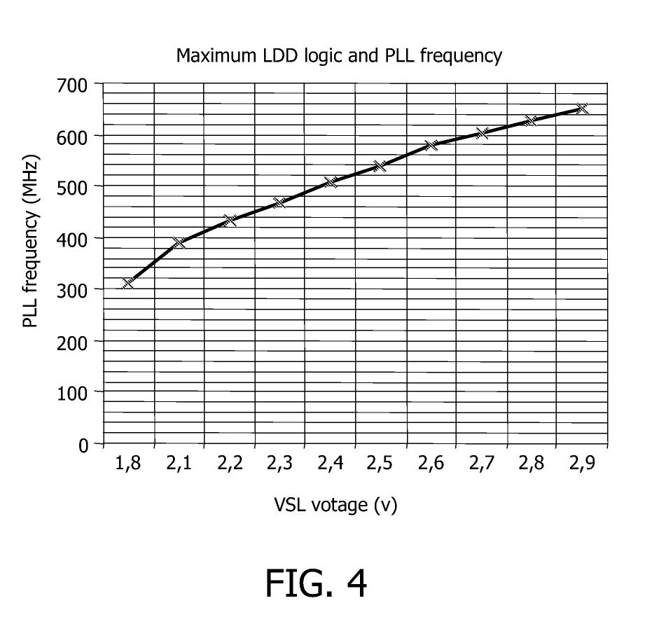

FIG. 4 is a graph showing the maximum phase lock loop (PLL) frequency in dependence on the supply voltage,

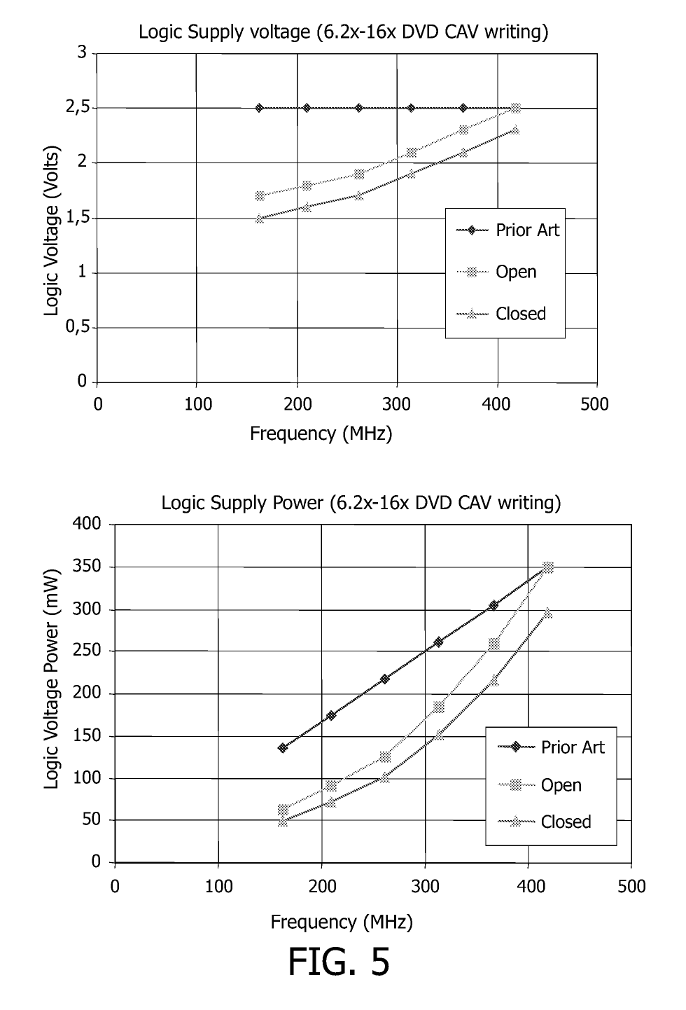

FIG. 5 shows two graphs demonstrating the reduced power consumption obtained by the present invention, and

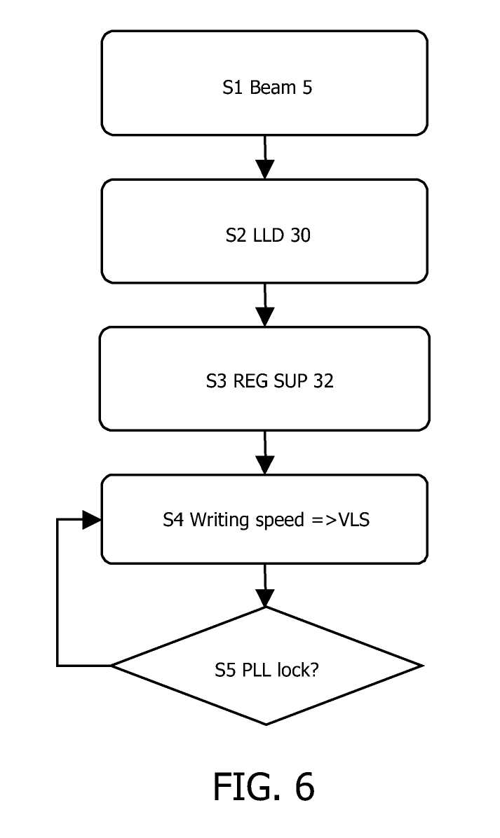

FIG. 6 is a flow-chart of a method according to the invention.

FIG. 1 shows an optical apparatus or drive and an optical information carrier 1 according to the invention. The carrier 1 is fixed and rotated by holding means 30.

The carrier 1 comprises a material suitable for recording information by means of a radiation beam 5. The recording material may, for example, be of the magneto-optical type, the phase-change type, the dye type, metal alloys like Cu/Si or any other suitable material. Information may be recorded in the form of optically detectable regions, also called marks for rewriteable media, on the carrier 1.

The apparatus comprises an optical head 20, sometimes called an optical pick-up (OPU), the optical head 20 being displaceable by actuation means 21, e.g. an electric stepping motor. The optical head 20 comprises a photo detection system 10, a laser driver device 30, a radiation source 4, a beam splitter 6, an objective lens 7, and lens displacement means 9 capable of displacing the lens 7 both in a radial direction of the carrier 1 and in the focus direction. The optical head 20 may also comprise beam splitting means 22, such as a grating or a holographic pattern capable of splitting the radiation beam 5 into at least three components for use in the three spot differential push-pull radial tracking, or any other applicable control method.

The function of the photo detection system 10 is to convert radiation 8 reflected from the carrier 1 into electrical signals. Thus, the photo detection system 10 comprises several photo detectors, e.g. photodiodes, charged-coupled devices (CCD), etc., capable of generating one or more electric output signals. The photo detectors are arranged spatially to one another and with a sufficient time resolution so as to enable detection of error signals, i.e. focus error FE and radial tracking error RE. The focus error FE and radial tracking error RE signals are transmitted to the processor 50 where commonly known servomechanism operated by usage of PID control means (proportional-integrate-differentiate) is applied for controlling the radial position and focus position of the radiation beam 5 on the carrier 1.

The radiation source 4 for emitting a radiation beam or a light beam 5 can for example be a semiconductor laser with a variable power, possibly also with variable wavelength of radiation. Alternatively, the radiation source 4 may comprise more than one laser. In the context of the present invention the term “light” is considered to comprise any kind of electromagnetic radiation suitable for optical recording and/or reproduction, such as visible light, ultraviolet light (UV), infrared light (IR), etc.

The radiation source 4 is controlled by the laser driver device (LDD) 30. The laser driver device (LDD) 30 comprises electronic circuitry means (not shown in FIG. 1) for providing a control current to the radiation source 4 in response to a clock signal CL and a data signal NRZ transmitted from the processor 50. An adjustable power supply 32 supplies the electronic circuitry means with power, the power level of the power supply 32 being adjustably controlled from the processor 50. According to the present invention the power level of the power supply 32 is adapted for being adjusted in response to the data writing speed to the optical carrier 1.

The processor 50 receives and analyses signals from the photo detection means 10. The processor 50 can also output control signals to the actuation means 21, the radiation source 4, the lens displacement means 9, and the rotating means 30, as schematically illustrated in FIG. 1. Similarly, the processor 50 can receive data, indicated at 61, and the processor 50 may output data from the reading process as indicated at 60.

FIG. 2 illustrates the present invention in a simplified block diagram where some elements of FIG. 1 are shown again. In particular, the processor 50 receives data 61 to be written on the carrier 1, and the processor 50 converts the data 61 to encoded data NRZ (no return to zero) according to an appropriate standard for the relevant recording technology. The data NRZ together with a corresponding clock signal is transmitted to the laser driver device 30 for converting the NRZ data to a pulse-train of drive current to the radiation source, e.g. a laser 4. The laser driver device 30 and the laser 4 are positioned in the OPU 20 as indicated in FIG. 2. The connection to the supply 32 and the processor 50 is through a flat flexible connector (not shown) also known as the “flex”.

The processor 50 also controls the power level of the regulated power supply REG_SUP 32 by transmitting a control signal CON_VSL to the power supply 32. The power supply is supplied by a raw supply 70, e.g. mains or a battery, depending on the application. The power supply 32 outputs a power level given by a voltage VSL. Hitherto, for the prior art solutions the output voltage of the power supply 32 has been nominally substantially fixed at e.g. 2.5 V or the like during writing, but the present invention allows this level to be dynamically adjusted in response to the writing speed of the optical drive.

FIG. 3 is a block diagram of a laser driver device 30 schematically showing the components comprised in the laser driver device 30. A data signal NRZ and a clocking signal CL is fed from the processor 50 (not shown). From the clocking signal CL a higher resolution clock is generated in a phase lock loop PLL circuit. Alternatively, a delay locked loop (DLL) may be applied. The NRZ clock frequency is set by the writing speed to the carrier 1. Hence, as the writing speed increases, the NRZ clock frequency increases and correspondingly the PLL clock frequency will increase. However, the NRZ clock frequency need not be the same as the channel clock frequency if the PLL provides means to multiply the incoming clock up to the channel clock rate.

The NRZ signal is fed to a mark/space length detector M/S, and further the data signal is transmitted to the write strategy generator WSG. The generator WSG controls a current drive circuit CUR for transmitting a control current to the laser 4 which in turn emits a corresponding laser beam 5 for writing appropriate marks to the carrier 1. The overall operation of the laser device drive 30 is controlled by a LDD controller LDD CON.

In advantageous embodiments of the present invention one or more of the electronic components of the laser device drive 30 is supplied at a reduced power level in dependence on the writing speed. Thus, in an embodiment of the invention the logic circuitry of the PLL is supplied at a reduced voltage level VSL. In FIG. 4, a graph showing the maximum phase lock loop (PLL) frequency in dependence on the supply voltage VSL is seen to have a near linear relationship. According to the present invention, use is made of this relationship to tune the supply voltage VLS of the logic circuitry at a given writing speed i.e. channel clock frequency, in order to minimize the LDD power dissipation. In general, logic circuits such as the standard CMOS has a power dissipation which is given by a fCV² relation, where f is the effective frequency of operation of the logic, C is the effective capacitance in the logic that is cycled from high-to-low and V is the voltage difference of the high and the low level with an additional small DC component for leakage/resistive loads in the circuit as shown in FIG. 4.

Depending on the writing speed, the processor 50 can control the value of the logic supply voltage VSL. This control may be analogue, e.g. the processor 50 may use a DAC to influence a regulator control feedback voltage so that the regulator output can take on a range of values determined by the DAC. Another simpler method may be to use a number of supply voltage levels VSL (e.g. one high for high speeds, one low for low speeds). A digitally controllable regulator may also be used.

In a embodiment of the invention, a closed loop or an iterative process is applied to adjust the power level VSL of the power supply REG_SUP to the electronic circuitry means by a calibration procedure where the processor 50 sets the supply voltage VSL based on a characteristic relation between the supply voltage and one or more control parameters of the electronic circuit means of the LDD 30. Thus, if the LDD 30 can monitor the voltage required during calibration or otherwise then a more accurate value of the supply voltage VSL can be used. One example is to design the system so that the PLL locking is the limiting factor at any given logic voltage VSL. By checking if the PLL is in lock it can be determined if a sufficiently large logic voltage VSL is being applied. Although some time may be used in the iteration process, an additional reduction in the power dissipation may be achieved. This is demonstrated in FIG. 5, see below.

If this iterative process is not applied, the settings of the supply voltage VLS in response to the writing speed may be given by a look-up-table in the LDD or an empirical functional relationship between the supply voltage VLS and the writing speed. This is a so-called open loop embodiment as there is no iterative feed-back. For the open loop embodiment, the settings are fixed either during the design stage or during factory adjustment. Appropriate safety margins for the supply voltage VSL should be taken into account in order not to reduce the functionality of the laser driver device LDD both from the open loop embodiment and for the iterative closed loop embodiment.

In FIG. 5, results demonstrate the adjusted supply voltage VSL and the reduced power consumption obtained by the present invention with an analogue (DAC) controlled regulated supply REG_SUP. In this example, an optical drive with 16× DVD CAV (constant angular velocity) writing of data to a disk occurs at 6.2× on the inside of the disk and 16× on the outside of the disk. But obviously the same method may be used for any other non-CLV (e.g. CAV, PCAV, ZCLV) type of writing speed profile and this can be done for any optical carrier. Thus, media like e.g. CD, DVD, HD-DVD or BD may benefit for the present invention.

For a prior art system the regulated standalone logic supply must be chosen for 16× performance (ca. 420 MHz because in this case the channel clock is 26.15625 MHz) throughout the disk. As seen in the upper graph of FIG. 5 the logic supply voltage VLS is constant at 2.5 V, whereas the open and closed loop embodiments of the present invention have a rising supply voltage VSL going from the inside of the disk to the outside of the disk. Thus, the logic supply VSL begins on the inside at a level sufficient for 6.2× and is raised by the processor 50 when required to operate at the required writing speed as writing progresses to the outside of the disk. In accordance with the present invention, the supply voltage VLS is adjusted in the interval from 1.7 V to 2.5 V. However, the teaching of the present invention is not limited to this voltage interval as the skilled person will realize once the general principle of the invention is acknowledged. Due to the inherent problem of power dissipation in logic circuitry, it is therefore contemplated that the present invention may find application particularly at even lower voltage levels.

In the lower graph of FIG. 5, the resulting power dissipation is shown for a prior art system and an open and closed loop embodiment of the present invention. As expected, the power dissipation of the prior art system rises linearly with frequency, but applying the present invention significantly reduces the power dissipation. Notice that the closed loop embodiment of the invention has lower power dissipation than the open loop embodiment.

FIG. 6 is a flow-chart of a method according to the invention for operating an optical drive. The method comprises the steps of:

S1: emitting a radiation beam 5 with a radiation source 4 for writing data with a pre-determined writing speed to the optical carrier 1,

S2: providing a control current from a laser driver device LDD comprising electronic circuitry means, e.g. PLL, M/S, LDD CON, WSG, CUR as shown in FIG. 3, for providing said control current to the radiation source 4 in response to a clock signal CL and a data signal NRZ,

S3: supplying the electronic circuitry means with an adjustable power supply REG_SUP, and

S4: adjusting a power level VSL of the power supply to at least part of the electronic circuitry means in response to the data writing speed to the optical carrier.

In an advantageous embodiment, the invention further includes a step S5, where an adjustment of the power level VSL to the electronic circuitry means is performed by a iterative procedure where the processor 50 sets the supply voltage VSL based on some characteristic relation between the supply voltage VSL and one or more control parameters of the electronic circuitry means of the LDD 30. One such control parameter could be the phase lock looping PLL, the decision being dependent on whether or not the PLL is locked.

Although the present invention has been described in connection with the specified embodiments, it is not intended to be limited to the specific form set forth herein. Rather, the scope of the present invention is limited only by the accompanying claims. In the claims, the term comprising does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. An optical drive capable of writing data to an associated optical carrier (1), the optical drive comprising:
a radiation source (4) capable of emitting a radiation beam (5) for writing data with a pre-determined writing speed to the associated optical carrier,
a laser driver device (LDD) comprising electronic circuitry means for providing a control current to the radiation source in response to a clock signal (CL) and a data signal (NRZ),
an adjustable power supply (REG_SUP, 32) supplying the electronic circuitry means,
wherein a power level (VSL) of the power supply to at least part of the electronic circuitry means is adapted for being adjusted in response to the data writing speed to the associated optical carrier.

2. An optical drive according to claim 1, wherein the electronic circuitry means comprises a clock generator for generating an internal clocking signal (PLL) from the clock signal (CL).

3. An optical drive according to claim 1, wherein the electronic circuitry means comprises a write strategy generator (WSG).

4. An optical drive according to claim 1, wherein the electronic circuitry means comprises a current drive means (CUR) for generating the control current to the radiation source (4).

5. An optical drive according to claim 1, wherein the electronic circuitry means comprises a laser driver device controller (LDD CON) for controlling the control current to the radiation source (4).

6. An optical drive according to claim 1, wherein the electronic circuitry means comprises logic circuitry means.

7. An optical drive according to claim 2, wherein the internal clocking signal has a clock frequency, said clock frequency having a maximum value being dependent on the power level of the power supply (REG_SUP, 32) to the clock generator (PLL).

8. An optical drive according to claim 1, wherein the power level of the power supply to at least part of the electronic circuitry means is minimized in dependence on the data writing speed to the associated optical carrier (1).

9. An optical drive according to claim 1, wherein the power level of the power supply to at least part of the electronic circuitry means is adjusted in an iterative process.

10. An optical drive according to claim 1, wherein a writing speed profile is chosen from the group of: constant angular velocity (CAV), pseudo constant angular velocity (PCAV), and zoned constant linear velocity (ZCLV).

11. A laser driver device (LDD) for controlling an associated radiation source (4) for writing data with a pre-determined writing speed to an associated optical carrier in an optical drive, the laser driver device comprising:
electronic circuitry means for providing a control current to the radiation source in response to an incoming clock signal (CL) and an incoming data signal (NRZ), the electronic circuitry means being adapted for being supplied by an associated adjustable power supply,
wherein at least part of the electronic circuitry means is adapted for operating with a power level being adjusted in response to the data writing speed to the associated optical carrier.

12. A method for operating an optical drive capable of writing data to an optical carrier (1), the method comprising the steps of:
emitting a radiation beam (5) with a radiation source (4) for writing data with a pre-determined writing speed to the optical carrier,
providing a control current from a laser driver device (LDD, 32) comprising electronic circuitry means for providing said control current to the radiation source (4) in response to a clock signal (CL) and a data signal (NRZ),
supplying the electronic circuitry means with an adjustable power supply (REG_SUP, 32), and
adjusting a power level (VSL) of the power supply to at least part of the electronic circuitry means in response to the data writing speed to the optical carrier.

13. A computer program product being adapted to enable a computer system comprising at least one computer having data storage means associated therewith to control an optical drive according to claim 12.
